(19) United States
(12) Patent Application Publication
(10) Pub. No.: US 2026/0341734 A1
(43) Pub. Date: Oct. 29, 2026

(54) LITHIUM-THIONYL CHLORIDE PRIMARY BATTERY AND PREPARATION METHOD THEREFOR

(71) Applicant: LONG SING TECHNOLOGY GROUP (HONG KONG) LIMITED, Hong Kong (CN)

(72) Inventors: Shengbo LU, Hong Kong (CN); Soon Yee LIEW, Hong Kong (CN); Zhenxiang XU, Hong Kong (CN); Yixiang XU, Hong Kong (CN)

(21) Appl. No.: 19/657,723

(22) Filed: Apr. 24, 2026

(30) Foreign Application Priority Data
Apr. 24, 2025 (CN) 202510522466.6

(51) Int. Cl. H01M 4/62; H01M 4/02; H01M 4/36; H01M 4/38; H01M 6/14; H01M 50/609

(52) U.S. Cl. CPC H01M 4/628; H01M 4/366; H01M 4/382; H01M 6/14; H01M 50/609; H01M 2004/021; H01M 2004/027; H01M 2300/002

(57) ABSTRACT

Provided are a lithium-thionyl chloride primary battery and a preparation method therefor. The lithium-thionyl chloride primary battery comprises a lithium anode, a separator, a cathode, and a thionyl chloride electrolyte; wherein the surface of the lithium anode is provided with a nano-metal coating layer and/or the thionyl chloride electrolyte comprises a metal phthalocyanine complex. The lithium-thionyl chloride primary battery can respond quickly to discharge requirement, does not suffer capacity loss when discharge is not required, and also exhibits an improved overall discharge capacity.

### CROSS-REFERENCE TO RELATED APPLICATION(S)

This application claims priority to Chinese Patent Application No. 202510522466.6 filed on Apr. 24, 2025, the disclosure of which is incorporated herein by reference in its entirety.

### TECHNICAL FIELD

The present disclosure belongs to the technical field of primary batteries, and specifically relates to a lithium-thionyl chloride primary battery and a preparation method therefor.

### BACKGROUND

Lithium-thionyl chloride primary batteries are non-rechargeable batteries and involve only discharge reactions. The overall discharge electrochemical reaction is as follows: 2SOCl₂+4Li→4LiCl+SO₂+S. In this reaction, SOCl₂ is thionyl chloride, which is a liquid cathode component and also serves as electrolyte (catholyte) accommodated in a porous carbon electrode or a cathode current collector; Li serves as the lithium anode and also the negative terminal of the battery. The overall discharge electrochemical reaction consists of two half-reactions, which occur at the lithium anode (Li→Li⁺+e) and at the cathode (2SOCl₂+4Li⁺+4e→4LiCl+SO₂+S). Therefore, during discharging, the lithium anode discharges and generates lithium ions and electrons. The electrons flow to the cathode of the battery through external circuit, while the lithium ions migrate within the battery. At the cathode, thionyl chloride meets electrons from the external circuit and lithium ions from the electrolyte and undergoes a reduction reaction.

However, in addition to occurring at the cathode for discharge as desired, the discharge reaction also takes place on the lithium surface due to direct contact between the lithium anode and the thionyl chloride catholyte within the battery. This reaction induces corrosion and leads to self-discharge through continuous consumption of the catholyte and metal lithium. Normally, when this reaction occurs on the metal lithium surface, a lithium chloride layer will be deposited thereto in the initial corrosion reaction, which exhibits a passivating effect on the metal lithium, inhibiting further rapid corrosion, and is therefore referred to as a passivation layer. However, the naturally formed passivation layer on the metal lithium surface has drawbacks: on one hand, it increases the impedance of subsequent battery discharge; on the other hand, it fails to provide complete corrosion protection for the metal lithium. Consequently, self-discharge persists during long-term storage or operation, ultimately leading to a significantly declined discharge capacity of the battery.

In addition, for lithium-thionyl chloride primary batteries discharged at a high discharge current, discharge limitation often occurs on the cathode side due to the inefficient electrochemical process of thionyl chloride reduction, thereby affecting the discharge performance of the battery.

Therefore, how to further improve the discharge performance of lithium-thionyl chloride primary batteries is an urgent technical problem to be solved.

### SUMMARY

In view of the shortcomings of the prior art, an object of the present disclosure is to provide a lithium-thionyl chloride primary battery and a preparation method therefor. In the present disclosure, the lithium anode is provided with a nano-metal coating layer on the surface and/or a metal phthalocyanine complex is introduced into the thionyl chloride electrolyte. The nano-metal coating layer can protect the lithium anode from being corroded by thionyl chloride, preventing battery self-discharge during storage or idle phase in intermittent discharge. Moreover, the nano-metal coating layer exhibits lithiophilicity, which can promote the migration of lithium ions toward the cathode. The metal phthalocyanine complex possesses a unique molecular structure and electron cloud distribution, enabling optimization of the reaction process at the electrode surface, allowing the reduction reaction of thionyl chloride to proceed more efficiently, reducing electrode polarization, thereby increasing the discharge voltage of the battery and enabling the battery to output stable and high voltage, and at the same time, the metal phthalocyanine complex reduces the resistance of the electrolyte and enhances the ion migration rate, thus improving the high-current discharge performance of the lithium-thionyl chloride primary battery.

To achieve the object of the present disclosure, the following technical solutions are adopted.

In a first aspect, the present disclosure provides a lithium-thionyl chloride primary battery, and the lithium-thionyl chloride primary battery comprises a lithium anode, a separator, a cathode, and a thionyl chloride electrolyte.

A surface of the lithium anode is provided with a nano-metal coating layer and/or the thionyl chloride electrolyte comprises a metal phthalocyanine complex.

In the present disclosure, the lithium anode is provided with a nano-metal coating layer on the surface and/or a metal phthalocyanine complex is introduced into the thionyl chloride electrolyte. The nano-metal coating layer can protect the lithium anode from being corroded by thionyl chloride, preventing self-discharge of the battery during storage or idle phase in intermittent discharge. Moreover, the nano-metal coating layer exhibits lithiophilicity and can produce a strong affinity for lithium ions. The metal phthalocyanine complex possesses a unique molecular structure and electron cloud distribution, enabling optimization of the reaction process at the electrode surface, allowing the reduction reaction of thionyl chloride to proceed more efficiently, reducing electrode polarization, thereby increasing the discharge voltage of the battery and enabling the battery to output stable and high voltage, and at the same time, the metal phthalocyanine complex reduces the resistance of the electrolyte and enhances the ion migration rate, thus improving the high-current discharge performance of the lithium-thionyl chloride primary battery. Therefore, by providing a nano-metal coating layer on the surface of the lithium anode and/or introducing a metal phthalocyanine complex into the thionyl chloride electrolyte, the lithium-thionyl chloride primary battery can respond quickly to discharge requirement, does not suffer capacity loss when discharge is not required, and also exhibits an improved overall discharge capacity. Furthermore, for lithium-thionyl chloride batteries that are discharged after high-temperature storage, the lithium anode shows no self-discharge phenomenon, demonstrating excellent stability. The potential hysteresis issue in lithium-thionyl chloride batteries is also alleviated, enabling full-capacity discharge.

In the present disclosure, the metal phthalocyanine complex is a class of compounds formed by the coordination bonding between phthalocyanine ligand and metal ion, which can promote the discharge reaction of lithium-thionyl chloride primary batteries, reduce discharge impedance, and increase electrode potential.

Preferably, a material of the nano-metal coating layer comprises any one or a combination of at least two of gold nanoparticles, silver nanoparticles, platinum nanoparticles, or tin nanoparticles.

Preferably, in the nano-metal coating layer, a particle size D50 of nano-metal particles is 20-70 nm, which may be, for example, 20 nm, 30 nm, 40 nm, 50 nm, 60 nm, or 70 nm.

In the present disclosure, the nano-metal particles of suitable particle size can better protect the lithium anode from being corroded by thionyl chloride, preventing self-discharge of the battery during storage or idle phase in intermittent discharge. Moreover, the nano-metal particles exhibit lithiophilicity, which generates a strong affinity for lithium ions.

Preferably, a thickness of the nano-metal coating layer is less than or equal to 2 μm, which may be, for example, 2 μm, 1.5 μm, 1 μm, 0.5 μm, 0.1 μm, 50 nm, or 10 nm, and preferably, 0.5-1 μm.

In the present disclosure, a nano-metal coating layer of suitable thickness can fully achieve its protective function and lithium migration-promoting function, and does not affect the overall thickness of the lithium anode during battery assembly, and also simultaneously reduces the extra cost of the coating material. It should be noted that even when the thickness of the nano-metal coating layer is as low as 50-100 nm, the corresponding effects can still be achieved.

Preferably, the metal phthalocyanine complex comprises any one or a combination of at least two of iron phthalocyanine, copper phthalocyanine, cobalt phthalocyanine, or nickel phthalocyanine, preferably, cobalt phthalocyanine and/or nickel phthalocyanine.

In the present disclosure, cobalt phthalocyanine and nickel phthalocyanine can better promote the discharge reaction of lithium-thionyl chloride primary batteries, reduce discharge impedance, and increase the electrode potential.

Preferably, in the thionyl chloride electrolyte, a concentration of the metal phthalocyanine complex is 0.5-4 mg/mL, which may be, for example, 0.5 mg/mL, 1 mg/mL, 1.5 mg/mL, 2 mg/mL, 2.5 mg/mL, 3 mg/mL, 3.5 mg/mL, or 4 mg/mL.

In the present disclosure, a suitable concentration of the metal phthalocyanine complex in the thionyl chloride electrolyte can improve the discharge performance of the battery, and can also synergistically enhance the discharge capacity of the battery by working synergistically with the nano-metal coating layer during high-temperature aging.

Preferably, in a case where the metal phthalocyanine complex is nickel phthalocyanine, a concentration of the metal phthalocyanine complex is 0.5-2 mg/mL, which may be, for example, 0.5 mg/mL, 1 mg/mL, 1.5 mg/mL, or 2 mg/mL.

Preferably, the thionyl chloride electrolyte comprises a lithium salt, and a concentration of the lithium salt is 0.7-1.4 mol/L, which may be, for example, 0.7 mol/L, 0.9 mol/L, 1.1 mol/L, 1.2 mol/L, 1.3 mol/L, or 1.4 mol/L.

Preferably, the lithium salt comprises any one or a combination of at least two of LiAlCl₄, LiBF₄, LiPF₆, or LiClO₄.

Preferably, the cathode is a porous carbon cathode.

It should be noted that the material of the separator is not limited in the present disclosure; for example, it can be a glass fiber separator.

In a second aspect, the present disclosure provides a preparation method for the lithium-thionyl chloride primary battery as described in the first aspect, and the preparation method comprises the following steps:
assembling the lithium anode, the separator, and the cathode, and then injecting the thionyl chloride electrolyte to obtain the lithium-thionyl chloride primary battery.

Before the assembly, a dispersion solution containing nano-metal particles is coated on a surface of the lithium anode, and then dried to form the nano-metal coating layer; and/or, the metal phthalocyanine complex is added to the thionyl chloride electrolyte.

Preferably, a solvent of the dispersion solution comprises any one or a combination of at least two of dimethylacetamide, dimethylformamide, N-methylpyrrolidone, or dimethyl sulfoxide.

Preferably, a coating method comprises any one or a combination of at least two of wire-rod coating, drop casting, spray coating, dip coating, blade coating, or roll coating.

Numerical range in the present disclosure includes not only the above-listed point values but also any unlisted point values within the numerical range. Due to the limitation of space and the consideration of simplicity, specific point values included in the range are not exhaustively listed in the present disclosure.

Compared with the prior art, the present disclosure has the following beneficial effects.

In the present disclosure, the lithium anode is provided with a nano-metal coating layer on the surface and/or a metal phthalocyanine complex is introduced into the thionyl chloride electrolyte. The nano-metal coating layer can protect the lithium anode from being corroded by thionyl chloride, preventing self-discharge of the battery during storage or idle phase in intermittent discharge. Moreover, the nano-metal coating layer exhibits lithiophilicity, which can promote the migration of lithium ions toward the cathode. The metal phthalocyanine complex possesses a unique molecular structure and electron cloud distribution, enabling optimization of the reaction process at the electrode surface, allowing the reduction reaction of thionyl chloride to proceed more efficiently, reducing electrode polarization, thereby increasing the discharge voltage of the battery and enabling the battery to output stable and high voltage, and at the same time, the metal phthalocyanine complex reduces the resistance of the electrolyte and enhances the ion migration rate, thus improving the high-current discharge performance of the lithium-thionyl chloride primary battery. Therefore, by providing a nano-metal coating layer on the surface of the lithium anode and/or introducing a metal phthalocyanine complex into the thionyl chloride electrolyte, the lithium-thionyl chloride primary battery can respond quickly to discharge requirement, does not suffer capacity loss when discharge is not required, and also exhibits an improved overall discharge capacity. Furthermore, for lithium-thionyl chloride batteries that are discharged after high-temperature storage, the lithium anode shows no self-discharge phenomenon, demonstrating excellent stability. The potential hysteresis issue in lithium-thionyl chloride batteries is also alleviated, enabling full-capacity discharge.

### BRIEF DESCRIPTION OF DRAWINGS

FIG. 1 is a physical photograph of the lithium anode provided in Example 1 of the present disclosure.

FIG. 2 is a surface SEM image of the lithium anode provided in Example 1 of the present disclosure.

FIG. 3 is a cross-sectional SEM image of the lithium anode provided in Example 1 of the present disclosure.

FIG. 4 is a physical photograph of the lithium anode provided in Example 4 of the present disclosure.

FIG. 5 is a surface SEM image of the lithium anode provided in Example 4 of the present disclosure.

FIG. 6 is a cross-sectional SEM image of the lithium anode provided in Example 4 of the present disclosure.

FIG. 7 is discharge curves of the lithium-thionyl chloride primary battery discharged in a horizontal status at a constant current of 2 mA provided in Example 1 of the present disclosure.

FIG. 8 is discharge curves of the lithium-thionyl chloride primary battery discharged in a vertical status at a constant current of 2 mA provided in Example 1 of the present disclosure.

FIG. 9 is discharge curves of the lithium-thionyl chloride primary battery discharged in a horizontal status at a constant current of 2 mA provided in Comparative Example 1 of the present disclosure.

FIG. 10 is discharge curves of the lithium-thionyl chloride primary battery discharged in a vertical status at a constant current of 2 mA provided in Comparative Example 1 of the present disclosure.

FIG. 11 is a statistical chart of the discharge capacities shown in FIGS. 7-10.

FIG. 12 is discharge curves of the lithium-thionyl chloride primary battery discharged in a horizontal status at a constant current of 10 mA provided in Example 1 of the present disclosure.

FIG. 13 is discharge curves of the lithium-thionyl chloride primary battery discharged in a horizontal status at a constant current of 10 mA provided in Comparative Example 1 of the present disclosure.

FIG. 14 is a statistical chart of the discharge capacities shown in FIGS. 12 and 13.

FIG. 15 is discharge curves of the lithium-thionyl chloride primary battery subjected to aging discharge at 60 °C and 10 mA provided in Example 1 of the present disclosure.

FIG. 16 is discharge curves of the lithium-thionyl chloride primary battery subjected to aging discharge at 60 °C and 10 mA provided in Comparative Example 1 of the present disclosure.

FIG. 17 is a statistical chart of the discharge capacities shown in FIGS. 15 and 16.

FIG. 18 is discharge curves of the lithium-thionyl chloride primary battery subjected to aging discharge at 60 °C and 2 mA provided in Example 1 of the present disclosure.

FIG. 19 is discharge curves of the lithium-thionyl chloride primary battery subjected to aging discharge at 60 °C and 2 mA provided in Comparative Example 1 of the present disclosure.

FIG. 20 is a statistical chart of the discharge capacities shown in FIGS. 18 and 19.

### DETAILED DESCRIPTION

The technical solutions of the present disclosure are further described below in terms of specific embodiments. It should be clear to those skilled in the art that the embodiments are merely used for a better understanding of the present disclosure and should not be regarded as a specific limitation to the present disclosure.

### Example 1

This example provides a lithium-thionyl chloride primary battery, and the lithium-thionyl chloride primary battery included a lithium anode, a separator, a cathode, and a thionyl chloride electrolyte. A surface of the lithium anode was provided with a nano-metal coating layer.

A material of the nano-metal coating layer was silver nanoparticles with a particle size D50 of 50 nm, and a thickness of the nano-metal coating layer was 800 nm. The separator was a glass fiber separator. The cathode was a porous carbon cathode. The thionyl chloride electrolyte included a lithium salt and a solvent, wherein the lithium salt was LiAlCl₄ with a concentration of 1 mol/L, and the solvent was thionyl chloride.

This example further provides a preparation method for the above lithium-thionyl chloride primary battery, and the preparation method comprises the following steps:
(1) by wire-rod coating, a dispersion solution containing silver nanoparticles was coated onto the surface of the lithium anode, and after drying, the nano-metal coating layer was formed; wherein a solvent of the dispersion solution was dimethylacetamide, and a concentration of the dispersion solution was 60 mg/mL; and
(2) the lithium anode with the nano-metal coating layer, the glass fiber separator, and the porous carbon cathode were assembled, and then the thionyl chloride electrolyte (having LiAlCl₄ at a concentration of 1 mol/L) was injected to obtain the lithium-thionyl chloride primary battery.

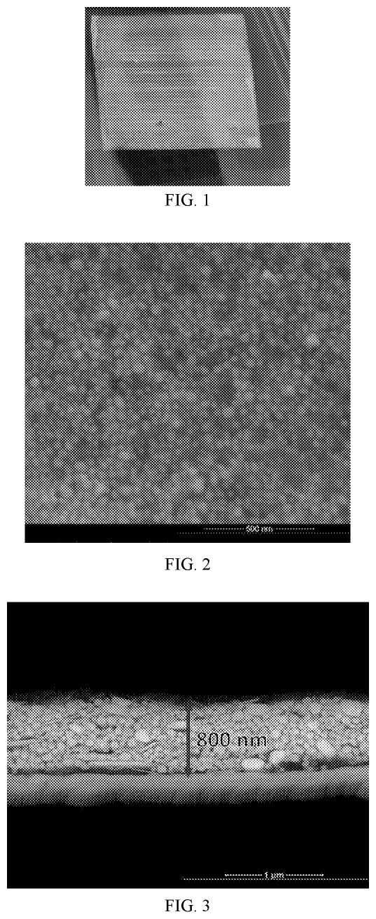

FIGS. 1 and 2 show a physical photograph and a surface SEM image of the lithium anode provided in this example, respectively. It can be seen from the figures that the lithium anode is provided with a silver nanoparticle coating on the surface, and the surface exhibits uniform particle size and excellent compactness.

FIG. 3 shows a cross-sectional SEM image of the lithium anode provided in this example. It can be seen from the figure that the thickness of the nano-metal coating layer is 800 nm, and the particle size is uniform in the vertical direction and the compactness is good.

### Example 2

This example provides a lithium-thionyl chloride primary battery, and the lithium-thionyl chloride primary battery included a lithium anode with a nano-metal coating layer, a separator, a cathode, and a thionyl chloride electrolyte.

A material of the nano-metal coating layer was gold nanoparticles with a particle size D50 of 20 nm, and a thickness of the nano-metal coating layer was 0.5 μm. The separator was a glass fiber separator. The cathode was a porous carbon cathode. The thionyl chloride electrolyte included a lithium salt and a solvent, wherein the lithium salt was LiAlCl₄ with a concentration of 0.7 mol/L, and the solvent was thionyl chloride.

This example further provides a preparation method for the above lithium-thionyl chloride primary battery, and the preparation method comprises the following steps:
(1) by blade coating, a dispersion solution containing gold nanoparticles was coated onto the surface of the lithium anode, and after drying, the nano-metal coating layer was formed; wherein a solvent of the dispersion solution was dimethylacetamide, and a concentration of the dispersion solution was 60 mg/mL; and
(2) the lithium anode with the nano-metal coating layer, the glass fiber separator, and the porous carbon cathode were assembled, and then the thionyl chloride electrolyte (having LiAlCl₄ at a concentration of 0.7 mol/L) was injected to obtain the lithium-thionyl chloride primary battery.

### Example 3

This example provides a lithium-thionyl chloride primary battery, and the lithium-thionyl chloride primary battery included a lithium anode with a nano-metal coating layer, a separator, a cathode, and a thionyl chloride electrolyte.

A material of the nano-metal coating layer was platinum nanoparticles with a particle size D50 of 70 nm, and a thickness of the nano-metal coating layer was 1 μm. The separator was a glass fiber separator. The cathode was a porous carbon cathode. The thionyl chloride electrolyte included a lithium salt and a solvent, wherein the lithium salt was LiAlCl₄ with a concentration of 1.4 mol/L, and the solvent was thionyl chloride.

This example further provides a preparation method for the above lithium-thionyl chloride primary battery, and the preparation method comprises the following steps:
(1) by drop casting, a dispersion solution containing platinum nanoparticles was coated onto the surface of the lithium anode, and after drying, the nano-metal coating layer was formed; wherein a solvent of the dispersion solution was dimethylacetamide, and a concentration of the dispersion solution was 60 mg/mL; and
(2) the lithium anode with the nano-metal coating layer, the glass fiber separator, and the porous carbon cathode were assembled, and then the thionyl chloride electrolyte (having LiAlCl₄ at a concentration of 1.4 mol/L) was injected to obtain the lithium-thionyl chloride primary battery.

### Example 4

This example differs from Example 1 in that the coating method in step (1) was wire-rod coating.

Other preparation method and parameters were consistent with those of Example 1.

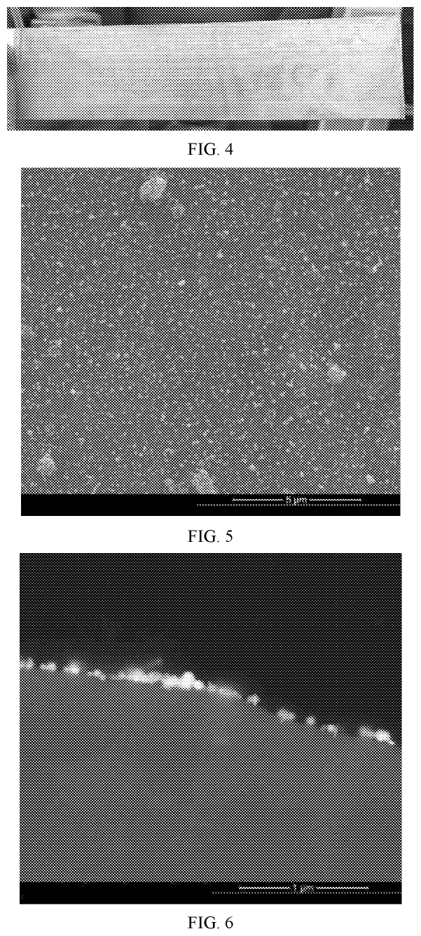

FIGS. 4 and 5 show a physical photograph and a surface SEM image of the lithium anode provided in this example. It can be seen from the figures that silver nanoparticles are uniformly distributed on the surface of the lithium anode.

FIG. 6 shows a cross-sectional SEM image of the lithium anode provided in this example. It can be seen from the figure that a particle size D50 of the silver nanoparticles is 50 nm.

### Example 5

This example provides a lithium-thionyl chloride primary battery, and the lithium-thionyl chloride primary battery included a lithium anode, a separator, a cathode, and a thionyl chloride electrolyte.

The separator was a glass fiber separator. The cathode was a porous carbon cathode. The thionyl chloride electrolyte included a lithium salt, a metal phthalocyanine complex, and a solvent, wherein the lithium salt was LiAlCl₄ with a concentration of 1 mol/L, the solvent was thionyl chloride, the metal phthalocyanine complex was iron phthalocyanine, and a concentration of the metal phthalocyanine complex was 0.5 mg/mL.

This example further provides a preparation method for the above lithium-thionyl chloride primary battery, and the preparation method comprises the following steps:
a thionyl chloride electrolyte was provided, wherein the thionyl chloride electrolyte included LiAlCl₄, iron phthalocyanine, and thionyl chloride; and
the lithium anode, the glass fiber separator, and the porous carbon cathode were assembled, and then the thionyl chloride electrolyte (having LiAlCl₄ at a concentration of 1 mol/L) was injected to obtain the lithium-thionyl chloride primary battery.

### Example 6

This example differs from Example 5 in that the metal phthalocyanine complex was copper phthalocyanine.

Other preparation method and parameters were consistent with those of Example 5.

### Example 7

This example differs from Example 5 in that the metal phthalocyanine complex was cobalt phthalocyanine.

Other preparation method and parameters were consistent with those of Example 5.

### Example 8

This example differs from Example 5 in that the metal phthalocyanine complex was nickel phthalocyanine.

Other preparation method and parameters were consistent with those of Example 5.

### Example 9

This example differs from Example 7 in that the concentration of cobalt phthalocyanine was 1 mg/mL.

Other preparation method and parameters were consistent with those of Example 7.

### Example 10

This example differs from Example 7 in that the concentration of cobalt phthalocyanine was 2 mg/mL.

Other preparation method and parameters were consistent with those of Example 7.

### Example 11

This example differs from Example 7 in that the concentration of cobalt phthalocyanine was 4 mg/mL.

Other preparation method and parameters were consistent with those of Example 7.

### Example 12

This example differs from Example 8 in that the concentration of nickel phthalocyanine was 1 mg/mL.

Other preparation method and parameters were consistent with those of Example 8.

### Example 13

This example differs from Example 8 in that the concentration of nickel phthalocyanine was 2 mg/mL.

Other preparation method and parameters were consistent with those of Example 8.

### Example 14

This example differs from Example 1 in that the thionyl chloride electrolyte in step (2) contained cobalt phthalocyanine, and a concentration of cobalt phthalocyanine was 0.5 mg/mL.

Other preparation method and parameters were consistent with those of Example 1.

### Example 15

This example differs from Example 1 in that the thionyl chloride electrolyte in step (2) contained nickel phthalocyanine, and a concentration of nickel phthalocyanine was 2 mg/mL.

Other preparation method and parameters were consistent with those of Example 1.

### Example 16

This example differs from Example 1 in that the thionyl chloride electrolyte in step (2) contained nickel phthalocyanine, and a concentration of nickel phthalocyanine was 2 mg/mL.

Other preparation method and parameters were consistent with those of Example 1.

### Example 17

This example differs from Example 1 in that the silver nanoparticles were replaced with micron-sized silver particles, with a particle size D50 of 2 μm.

Other preparation method and parameters were consistent with those of Example 1.

### Comparative Example 1

This comparative example differs from Example 1 in that no nano-metal coating layer was provided on the surface of the lithium anode, that is, step (1) was not carried out.

Other preparation method and parameters were consistent with those of Example 1.

### Comparative Example 2

This comparative example differs from Example 7 in that nickel phthalocyanine was not contained in the thionyl chloride electrolyte.

Other preparation method and parameters were consistent with those of Example 7.

### Performance Test

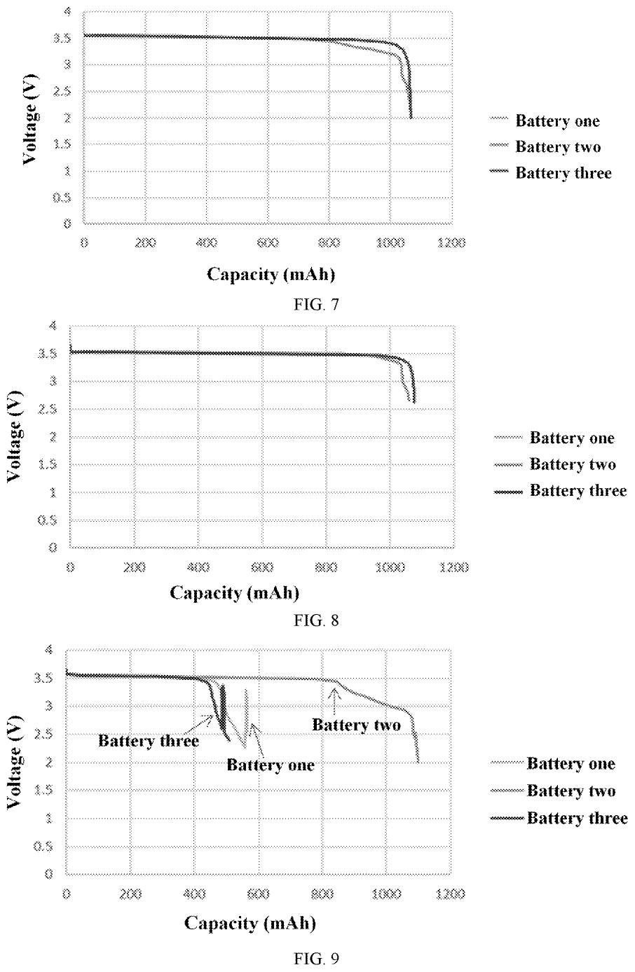

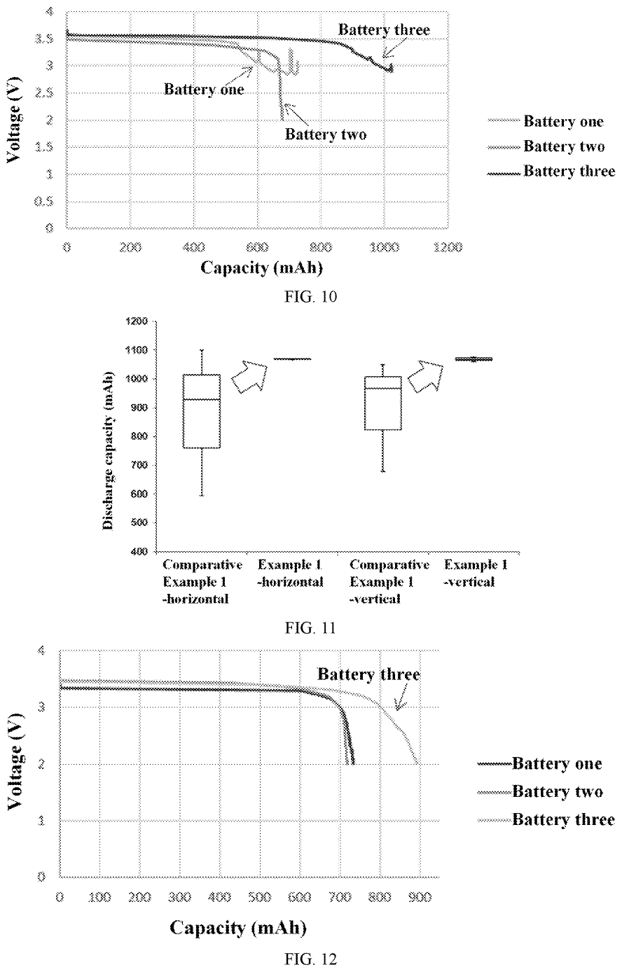

Several lithium-thionyl chloride primary batteries provided in Example 1 were subjected to discharge tests at a constant current of 2 mA, where the batteries were placed in horizontal or vertical orientations. The test results are shown in FIGS. 7 and 8. Several lithium-thionyl chloride primary batteries provided in Comparative Example 1 were subjected to discharge tests at a constant current of 2 mA, where the batteries were placed in horizontal or vertical orientations. The test results are shown in FIGS. 9 and 10. The discharge capacities of the batteries after the above discharge tests were statistically analyzed, and the resulting statistical graph of discharge capacities is shown in FIG. 11. The results indicate that the nano-metal coating layer improves the consistency of discharge capacity of the lithium-thionyl chloride primary batteries in each orientation.

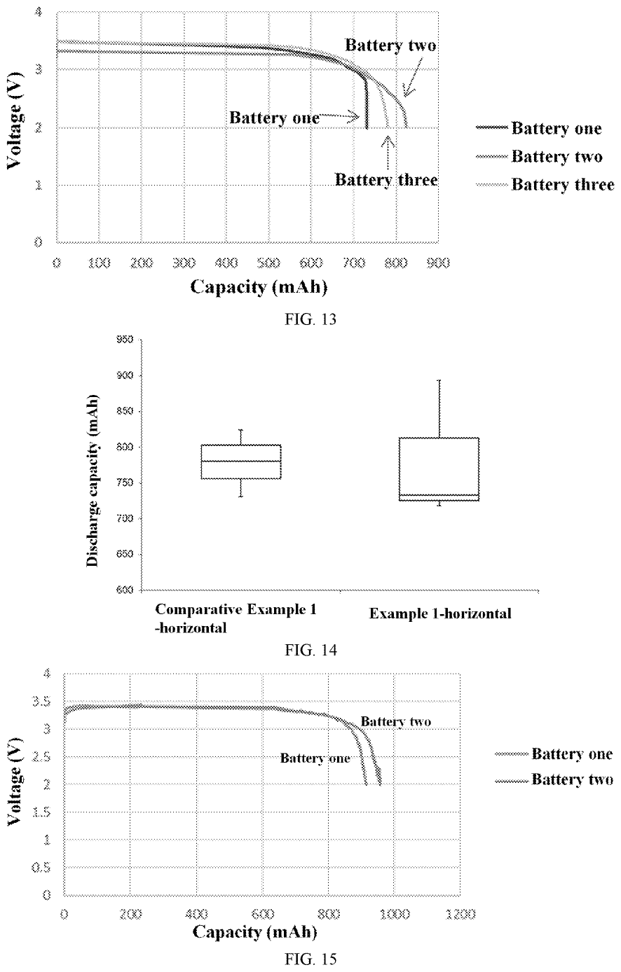

Several lithium-thionyl chloride primary batteries provided in Example 1 were subjected to discharge tests at a constant current of 10 mA with the batteries placed in a horizontal orientation. The test results are shown in FIG. 12. Several lithium-thionyl chloride primary batteries provided in Comparative Example 1 were subjected to discharge tests at a constant current of 2 mA with the batteries placed in a horizontal orientation. The test results are shown in FIG. 13. The discharge capacities of the batteries after the above discharge tests were statistically analyzed, and the resulting statistical graph of discharge capacities is shown in FIG. 14. The results indicate that under high-current conditions, the nano-metal coating layer does not significantly improve the discharge performance of the batteries.

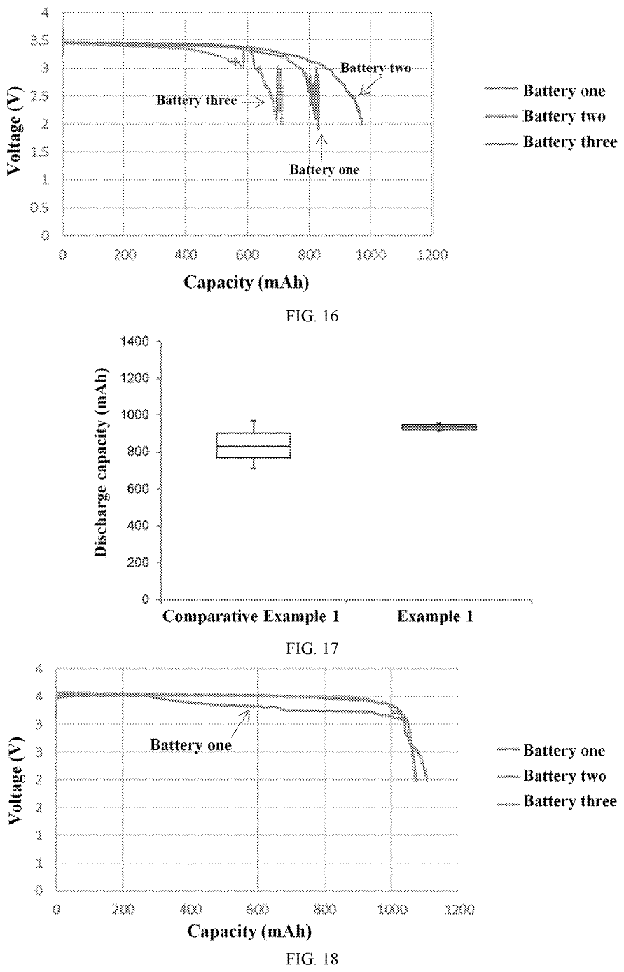

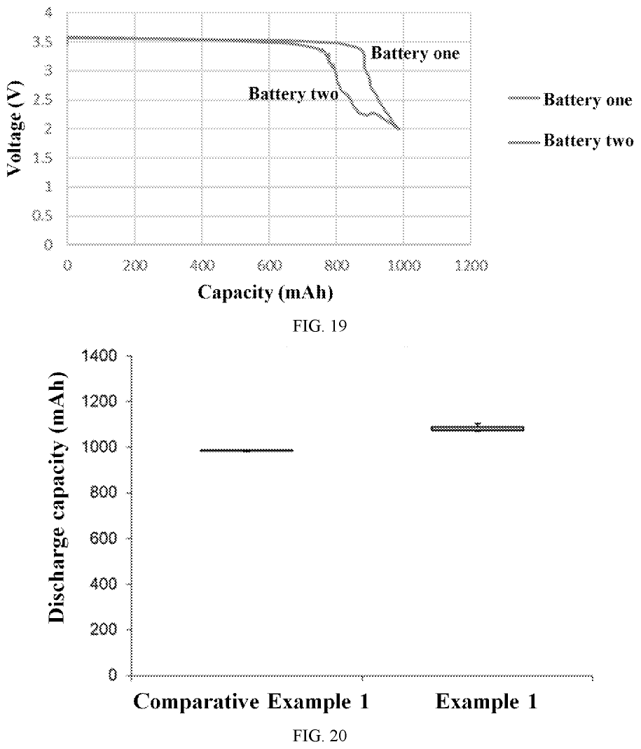

Discharge tests after thermal aging were conducted on several lithium-thionyl chloride primary batteries provided in Example 1 and Comparative Example 1 in a horizontal status, comprising: 1) the discharge test after thermal aging was performed at a constant current of 10 mA, after an aging period of 20 days at an aging temperature of 60 °C. The discharge test was carried out at RT conditions. The test results are shown in FIGS. 15 and 16, and the discharge capacities after the discharge tests were statistically analyzed, with the results shown in FIG. 17. The results indicate that providing a nano-metal coating layer on the metal lithium improves the discharge capacity of the aged lithium-thionyl chloride primary batteries under a discharge current of 10 mA in the horizontal status, and also improves the consistency of battery performance. 2) The discharge test after thermal aging was performed at a constant current of 2 mA, after an aging period of 20 days at an aging temperature of 60 °C. The test results are shown in FIGS. 18 and 19, and the discharge capacities after the discharge tests were statistically analyzed, with the results shown in FIG. 20. The results indicate that providing a nano-metal coating layer on the metal lithium improves the discharge capacity of the aged lithium-thionyl chloride primary batteries under a discharge current of 2 mA in the horizontal status, and also improves the consistency of battery performance.

At room temperature of 25 °C, discharge capacity tests were conducted on several lithium-thionyl chloride primary batteries provided in Example 5, Example 6, Example 7, Example 8, and Comparative Example 2 at a direct current of 10 mA, and the average values were taken. The test results are shown in Table 1.

TABLE 1

Discharge capacity (mAh)

| | 1 | 2 | 3 | Average value |
|---|---|---|---|---|
| Example 5 | 636.28 | 686.85 | 712.71 | 678.61 |
| Example 6 | 468.53 | 908.00 | 451.28 | 609.27 |
| Example 7 | 937.98 | 871.53 | 963.09 | 924.20 |
| Example 8 | 831.53 | 947.25 | 587.68 | 788.82 |
| Comparative | 612.60 | 431.33 | 930.31 | 658.08 |
| Example 2 | | | | |

As can be seen from Table 1, the introduction of the metal phthalocyanine complex helps improve the discharge performance of the battery. Using cobalt phthalocyanine or nickel phthalocyanine as an additive introduced into the thionyl chloride electrolyte exhibits the best effect on enhancing the discharge performance of the battery.

Several lithium-thionyl chloride primary batteries provided in Example 7, Example 9, Example 10, Example 11, and Comparative Example 2 were subjected to a discharge test after thermal aging at a constant current of 2 mA, and the average values were taken. The aging conditions were 60 °C for 20 days.

The test results are shown in Table 2.

TABLE 2

| | Discharge capacity (mAh) | | | | Transient |
|---|---|---|---|---|---|
| | | | | Average | minimum |
| | 1 | 2 | 3 | value | voltage (V) |
| Example 7 | 1005.97 | 1073.39 | 1070.83 | 1050.06 | 3.45 |
| Example 9 | 1000.79 | 945.77 | 1001.03 | 982.53 | 3.46 |
| Example 10 | 927.30 | 987.69 | 1035.14 | 983.38 | 3.40 |
| Example 11 | 815.34 | 424.14 | 659.35 | 632.94 | 3.21 |
| Comparative | 1111.90 | 1038.86 | 1031.46 | 1060.74 | 3.45 |
| Example 2 | | | | | |

As can be seen from Table 2, when cobalt phthalocyanine is used as an additive introduced into the thionyl chloride electrolyte at a concentration of 1-4 mg/mL, the battery performance deteriorates after aging at 60 °C for 20 days, and the higher the concentration, the worse the performance. However, when the concentration of cobalt phthalocyanine in the thionyl chloride electrolyte is 0.5 mg/mL, the thermal aging performance of the battery remains stable.

Several lithium-thionyl chloride primary batteries provided in Example 7, Example 9, Example 10, Example 11, and Comparative Example 2 were subjected to a discharge test after thermal aging at a constant current of 10 mA, and the average values were taken. The aging conditions were 60 °C for 20 days.

The test results are shown in Table 3.

TABLE 3

| | Discharge capacity (mAh) | | | | Transient |
|---|---|---|---|---|---|
| | | | | Average | minimum |
| | 1 | 2 | 3 | value | voltage (V) |
| Example 7 | 858.48 | 937.20 | 876.47 | 890.72 | 3.03 |
| Example 9 | 913.67 | 899.59 | 905.24 | 906.17 | 3.05 |
| Example 10 | 761.44 | 861.13 | 820.38 | 814.32 | 3.10 |
| Example 11 | 913.94 | 881.47 | 824.17 | 873.19 | 2.96 |
| Comparative | 1034.53 | 992.63 | 907.87 | 978.34 | 3.05 |
| Example 2 | | | | | |

As can be seen from Table 3, under high current conditions, merely introducing nickel phthalocyanine into the thionyl chloride electrolyte has little effect on the thermal aging performance of the battery.

Several lithium-thionyl chloride primary batteries provided in Example 8, Example 12, Example 13, and Comparative Example 2 were subjected to a discharge test after thermal aging at a constant current of 2 mA, and the average values were taken. The aging conditions were 60 °C for 20 days.

The test results are shown in Table 4.

TABLE 4

| | Discharge capacity (mAh) | | | | Transient |
|---|---|---|---|---|---|
| | | | | Average | minimum |
| | 1 | 2 | 3 | value | voltage (V) |
| Example 8 | 716.84 | 1068.24 | 903.73 | 896.3 | 3.04 |
| Example 12 | 952.59 | 1083.72 | 1008.87 | 1015.06 | 3.41 |
| Example 13 | 955.62 | 989.02 | 989.82 | 978.15 | 3.29 |
| Comparative | 1111.90 | 1038.86 | 1031.46 | 1060.74 | 3.45 |
| Example 2 | | | | | |

As can be seen from Table 4, when nickel phthalocyanine is used as an additive introduced into the thionyl chloride electrolyte, the concentration increase of nickel phthalocyanine, even reaching 2 mg/mL, does not have an adverse effect on the thermal aging performance of the battery.

Several lithium-thionyl chloride primary batteries provided in Example 8, Example 12, Example 13, and Comparative Example 2 were subjected to a discharge test after thermal aging at a constant current of 10 mA, and the average values were taken. The aging conditions were 60 °C for 20 days.

The test results are shown in Table 5.

TABLE 5

| | Discharge capacity (mAh) | | | | Transient |
|---|---|---|---|---|---|
| | | | | Average | minimum |
| | 1 | 2 | 3 | value | voltage (V) |
| Example 8 | 902.5 | 949.7 | 990.1 | 947.43 | 2.27 |
| Example 12 | 975.5 | 982.4 | 994.7 | 984.2 | 2.88 |
| Example 13 | 824.1 | 752.3 | 774.2 | 783.5 | 2.42 |
| Comparative | 1034.53 | 992.63 | 907.87 | 978.34 | 3.05 |
| Example 2 | | | | | |

As can be seen from Table 5, under high current conditions, when nickel phthalocyanine is used as an additive introduced into the thionyl chloride electrolyte, a low concentration of nickel phthalocyanine does not have an adverse effect on the thermal aging performance of the battery.

Several lithium-thionyl chloride primary batteries provided in Example 1, Example 7, Example 13, Example 14, Example 15, and Comparative Example 1 were subjected to a discharge test after thermal aging at a constant current of 2 mA, and the average values were taken. The aging conditions were 70 °C for 30 days.

The test results are shown in Table 6.

TABLE 6

| | Discharge capacity (mAh) | | | Transient |
|---|---|---|---|---|
| | | | Average | minimum |
| | 1 | 2 | value | voltage (V) |
| Example 1 | 928.131 | 900.780 | 914.450 | 3.48 |
| Example 15 | 1021 | 1032.8 | 1026.9 | 2.78 |
| Comparative | 860.817 | 908.966 | 884.89 | 3.49 |
| Example 1 | | | | |

As can be seen from Table 6, in the case where nickel phthalocyanine is used as an additive introduced into the thionyl chloride electrolyte, and at the same time, a silver nanoparticle coating layer is provided on the surface of the lithium anode, the synergism between nickel phthalocyanine and silver nanoparticle coating significantly enhances the discharge capacity of the battery and contributes to excellent thermal-aging stability.

Furthermore, as can be seen from the comparison between Example 1 and Example 17, if micron-sized silver particles are coated on the surface of the lithium anode to form a micron-metal coating, the minimum achievable thickness is at least in the D50 range of micron silver or thicker (the thickness would be 2 microns or more), and it would be more difficult to maintain uniform thickness. Moreover, an excessively thick coating on the lithium sheet may affect battery assembly. In addition, using micron-sized silver particles would directly introduce more silver into the battery lithium sheet, which would increase additional costs and is not conducive to cost reduction and benefit increase.

It should be noted that the present disclosure illustrates the method of the present disclosure by the above examples, but the present disclosure is not limited to the above process steps, that is, the present disclosure does not necessarily rely on the above process steps to be implemented. Those skilled in the art should understand that any improvements of the present disclosure, the equivalent substitution of each raw material, the addition of auxiliary ingredients, and the selection of specific methods shall fall within the protection scope and disclosure scope of the present disclosure.

What is claimed is:

1. A lithium-thionyl chloride primary battery, comprising a lithium anode, a separator, a cathode, and a thionyl chloride electrolyte;
wherein a surface of the lithium anode is provided with a nano-metal coating layer and the thionyl chloride electrolyte comprises a metal phthalocyanine complex;
a thickness of the nano-metal coating layer is 0.8-2 μm.

2. The lithium-thionyl chloride primary battery according to claim 1, wherein a material of the nano-metal coating layer comprises any one or a combination of at least two of gold nanoparticles, silver nanoparticles, platinum nanoparticles, or tin nanoparticles.

3. The lithium-thionyl chloride primary battery according to claim 1, wherein in the nano-metal coating layer, a particle size D50 of nano-metal particles is 20-70 nm.

4. The lithium-thionyl chloride primary battery according to claim 1, wherein the metal phthalocyanine complex comprises any one or a combination of at least two of iron phthalocyanine, copper phthalocyanine, cobalt phthalocyanine, or nickel phthalocyanine.

5. The lithium-thionyl chloride primary battery according to claim 4, wherein the metal phthalocyanine complex is cobalt phthalocyanine and/or nickel phthalocyanine.

6. The lithium-thionyl chloride primary battery according to claim 1, wherein in the thionyl chloride electrolyte, a concentration of the metal phthalocyanine complex is 0.5-4 mg/mL.

7. The lithium-thionyl chloride primary battery according to claim 1, wherein the thionyl chloride electrolyte comprises a lithium salt, and a concentration of the lithium salt is 0.7-1.4 mol/L;
the lithium salt comprises any one or a combination of at least two of LiAlCl₄, LiBF₄, LiPF₆, or LiClO₄;
the cathode is a porous carbon cathode.

8. A preparation method for the lithium-thionyl chloride primary battery according to claim 1, which comprises the following steps:
assembling the lithium anode, the separator, and the cathode, and then injecting the thionyl chloride electrolyte to obtain the lithium-thionyl chloride primary battery;
wherein before the assembly, a dispersion solution containing nano-metal particles is coated on a surface of the lithium anode, and then dried to form the nano-metal coating layer; the metal phthalocyanine complex is added to the thionyl chloride electrolyte.

9. The preparation method for the lithium-thionyl chloride primary battery according to claim 8, wherein a solvent of the dispersion solution comprises any one or a combination of at least two of dimethylacetamide, dimethylformamide, N-methylpyrrolidone, or dimethyl sulfoxide.

10. The preparation method for the lithium-thionyl chloride primary battery according to claim 9, wherein a coating method comprises any one or a combination of at least two of wire-rod coating, drop casting, spray coating, dip coating, blade coating, or roll coating.
